(19) United States
(12) Patent Application Publication
(10) Pub. No.: US 2019/0122047 A1
(43) Pub. Date: Apr. 25, 2019

(54) WORK SUPPORT SYSTEM, IMAGE PICKUP APPARATUS, WEARABLE APPARATUS AND WORK SUPPORT METHOD

(71) Applicant: OLYMPUS CORPORATION, Tokyo (JP)

(72) Inventors: Tatsuyuki UEMURA, Tokyo (JP); Yoji OSANAI, Tokyo (JP); Yuji MIYAUCHI, Tokyo (JP); Kazuhiko OSA, Tokyo (JP); Osamu NONAKA, Kanagawa (JP)

(73) Assignee: OLYMPUS CORPORATION, Tokyo (JP)

(21) Appl. No.: 16/165,149

(22) Filed: Oct. 19, 2018

(30) Foreign Application Priority Data
Oct. 20, 2017 (JP) 2017-203978

(51) Int. Cl. G06K 9/00; H04N 5/76; H04N 5/232; G06F 1/16

(52) U.S. Cl. CPC G06K 9/00671; H04N 5/76; H04N 5/445; G06F 1/163; G06K 2209/27; H04N 5/232

(57) ABSTRACT

A work support system according to the present invention includes: an image pickup apparatus configured to acquire image data; a control apparatus configured to acquire pieces of process information chronologically managed in a database; and a recording apparatus configured to record the image data acquired by the image pickup apparatus, in association with meta data including a piece of process information corresponding to the image data, from among the pieces of process information acquired by the control apparatus, and shooting time information.

### CROSS REFERENCE TO RELATED APPLICATION

This application claims the benefit of Japanese Application No. 2017-203978 filed in Japan on Oct. 20, 2017, the contents of which are incorporated herein by this reference.

### BACKGROUND OF THE INVENTION

### 1. Field of the Invention

This invention relates to a work support system, an image pickup apparatus, a wearable apparatus and a work support method for supporting predetermined work, a work procedure of which is prescribed.

### 2. Description of the Related Art

Conventionally, various industrial products (manufactured articles) have widely been prevalent. Examples of types of work for various industrial products (manufactured articles) include various types of work such as work of manufacturing and assembling in a manufacturing process, work of using such manufactured articles (handling work) and maintenance work (e.g., maintenance, inspection, adjustment and repair) for the manufactured articles. In many cases, respective predetermined work procedures, methods, etc., are clearly prescribed for the respective types of work. Some of these types of work are performed by means of manual operation by operators.

Each of these types of work includes a wide variety of tasks for each manufactured article, which is an object. Each of the tasks may involve a complicated procedure, or as necessary, need a confirmation task. Therefore, in order to reliably perform prescribed work, an operator accurately memorizes a whole predetermined work procedure or proceeds the work while referring to a manual such as an operating manual.

However, a lot of skills are required to reliably memorize all of a predetermined series of tasks and always perform the tasks correctly. When an operator pursues work referring to a manual such as an operating manual, for example, the operator stops the work each time the operator refers to references, resulting in hindrance of smooth work and consumption of a length of time beyond necessity.

Therefore, for work support systems for supporting an operator when the operator performs predetermined work, a work procedure of which is clearly prescribed, various proposals have been made by, for example, Japanese Patent Application Laid-Open Publication No. 2017-75001, etc.

The work support system disclosed in Japanese Patent Application Laid-Open Publication No. 2017-75001 above is a work support system for guiding a work procedure for a mobile crane. The work support system is configured using, for example, a wearable-type observation apparatus in order to correctly guide an operator according to a predetermined work procedure.

The work support system includes a remote operation apparatus including a detection apparatus configured to detect a state of a work machine, a transmission section configured to transmit the state of the work machine detected by the detection apparatus, an operation section configured to remotely operate the work machine, a display section configured to display a work procedure and a reception section configured to receive the state of the work machine transmitted by the transmission section, and the work support system is configured so that the display section provided in the remote operation apparatus displays a prescribed work procedure based on the received state of the work machine.

Such configuration enables the above work support system to arbitrarily display a detailed explanation of a relevant work content of each work process on a display screen of the observation apparatus, and thus, an operator can always follow a work procedure correctly without memorizing the work procedure in advance.

### SUMMARY OF THE INVENTION

A work support system according to an aspect of the present invention includes: an image pickup apparatus configured to acquire image data; a control apparatus configured to acquire pieces of process information chronologically managed in a database; and a recording apparatus configured to record the image data acquired by the image pickup apparatus, in association with meta data including a piece of process information corresponding to the image data, from among the pieces of process information acquired by the control apparatus, and shooting time information.

An image pickup apparatus according to an aspect of the present invention includes: an image pickup unit configured to acquire image data; a communication apparatus configured to communicate with a database in which work information including image information relating to predetermined work is accumulated in advance; a control apparatus configured to acquire pieces of information on work performed; and a recording apparatus configured to record the image data acquired by the image pickup unit, in association with meta data including a piece of work information corresponding to the image data from among the pieces of work information acquired by the control apparatus.

A wearable apparatus according to an aspect of the present invention includes: an image pickup unit configured to acquire image data corresponding to an operator's visual line; a communication apparatus configured to communicate with a database in which work information including image information relating to predetermined work is accumulated in advance; a control apparatus configured to acquire pieces of work information on work performed; and a recording apparatus configured to record the image data acquired by the image pickup unit, in association with meta data including a piece of work information corresponding to the image data from among the pieces of work information acquired by the control apparatus.

A work support method according to an aspect of the present invention includes: a process information acquisition step of acquiring particular pieces of process information from a plurality of pieces of process information chronologically managed in a database; an image acquisition step of acquiring image data; and a recording step of recording the image data, in association with meta data including a piece of process information corresponding to the image data and shooting time information.

Benefits of this invention will be further clarified by the following detailed description.

### BRIEF DESCRIPTION OF THE DRAWINGS

FIG. 1 is a schematic block configuration diagram illustrating a configuration of a work support system according to an embodiment of the present invention;

FIG. 2 is a conceptual diagram illustrating a schematic configuration of an image pickup apparatus (wearable terminal apparatus) forming a part of the work support system according to the embodiment of the present invention;

FIG. 3 is a conceptual diagram illustrating an operator wearing an image pickup apparatus (wearable terminal apparatus) as viewed from the front of the face of the operator and the operator's both eyes field of vision;

FIG. 4 is a conceptual diagram illustrating the operator's both eyes field of vision illustrated in FIG. 3 in more detail;

FIG. 5 is a flowchart illustrating a flow of tasks to be performed by an operator in medical instrument maintenance work (instrument cleaning/sterilizing work);

FIG. 6 is a diagram illustrating an example of evidence information created in maintenance work;

FIG. 7 is a conceptual diagram illustrating how predetermined maintenance work (instrument cleaning/sterilizing work) is performed using the work support system according to the embodiment of the present invention;

FIG. 8 illustrates example display of an image based on image data acquired by a wearable terminal apparatus during a task in maintenance work (instrument cleaning/sterilizing work) using the work support system according to the embodiment of the present invention;

FIG. 9 is a flowchart illustrating operation of a control apparatus in the work support system according to the embodiment of the present invention;

FIG. 10 is a flowchart illustrating operation of a wearable terminal apparatus (first image pickup apparatus) in the work support system according to the embodiment of the present invention;

FIG. 11 illustrates an example of a database assuming scissors cleaning/sterilizing work;

FIG. 12 illustrates an example of a still image acquired when an operator holds a predetermined tool (brush) in his/her right hand up to a front face of a wearable terminal apparatus (within an image pickup range), for a “tool confirmation” task;

FIG. 13 is a conceptual diagram illustrating how predetermined maintenance work (instrument cleaning/sterilizing work) is performed using a work support system according to a modification of the embodiment of the present invention;

FIG. 14 is a diagram illustrating one scene of movie data acquired by a wearable terminal apparatus in the modification in FIG. 13; and

FIG. 15 is a diagram illustrating still image data acquired by an auxiliary camera in the modification in FIG. 13.

### DETAILED DESCRIPTION OF THE PREFERRED EMBODIMENT

The present invention will be described below based on the embodiment illustrated in the drawings. Each of the drawings used for the below description is a schematic one, and in order to illustrate respective components in sizes that are large enough to be recognized in the drawings, the components may be illustrated so as to be different in, e.g., scale and dimensional relationship between members. Therefore, the present invention is not limited to the illustrated forms in terms of, e.g., the number of the components, shapes of the components, ratios in size among the components and relative positional relationships among the respective components indicated in each drawing.

### Embodiment

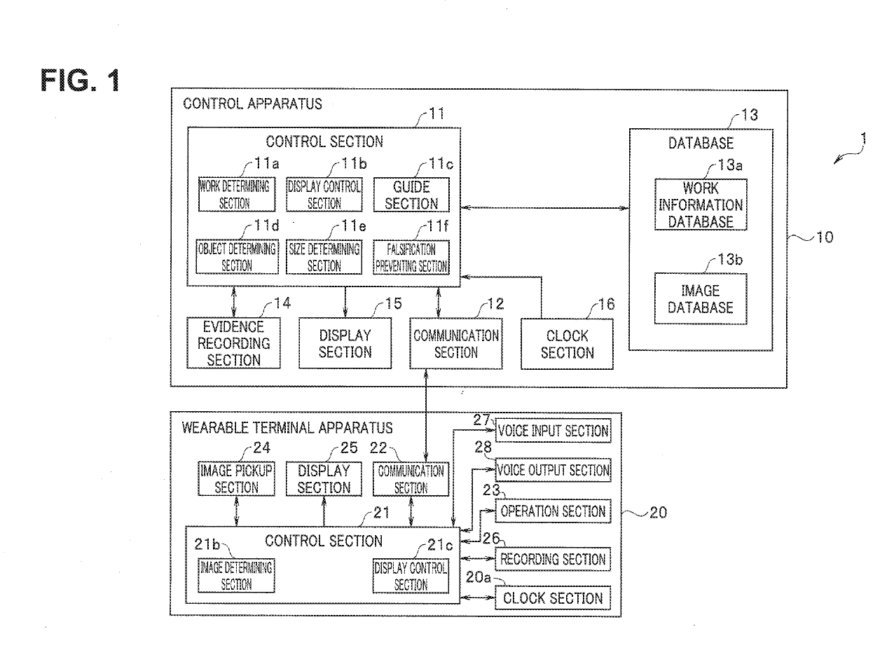

First, a schematic configuration of a work support system according to an embodiment of the present invention will be described below with reference to FIG. 1. FIG. 1 is a schematic block configuration diagram illustrating a configuration of a work support system according to an embodiment of the present invention.

The work support system 1 according to the present embodiment is a work support system that provides work support for reliably performing predetermined sequential work including a plurality of tasks according to a prescribed procedure and method and can record evidence relating to each of the tasks performed.

Normally, a strict work procedure is prescribed and the work procedure needs to be followed faithfully for this type of work. For example, in, e.g., the medical field, where, e.g., work for cleaning an instrument used for various kinds of treatment, surgery or the like is performed, a series of tasks including a task of cleaning a predetermined part of an object instrument or the like and a subsequent observation task of confirming a state of the cleaning of the predetermined part is repeated. Then, this type of work needs to be smoothly and efficiently performed to reduce risks of contamination.

Furthermore, in recent years, a system capable of recording evidence information such as recording, as evidence information indicating that each of a series of tasks has reliably been performed as prescribed, e.g., a state of an object before and after the task and progress of the task in the form of images has been desired as a countermeasure for responding to various types of troubles, for example.

Therefore, the work support system 1 includes an image pickup apparatus and a control apparatus configured to control the image pickup apparatus. In the present embodiment, an example of the work support system 1 including an image pickup apparatus (wearable terminal apparatus 20) and a control apparatus 10 is illustrated as in FIG. 1.

Based on a collection of pieces of information relating to a plurality of tasks determined in advance (database) and a plurality of image data relating to actually-performed tasks (acquired image data), such a configuration allows the work support system 1 according to the present embodiment to perform confirmation and determination relating to the tasks such as displaying individual work contents included in the relevant sequential work and a work procedure to provide a work guide and determining whether or not the work procedure has correctly been followed, and provide work support such as performing evidence recording if the work has been performed correctly, and issuing a warning to an operator to remind the operator to perform the work correctly if the work has been performed erroneously.

More specifically, the work support system 1 according to the present embodiment includes a wearable terminal apparatus 20, which is an image pickup apparatus as well as a wearable apparatus, and a control apparatus 10 configured to control the wearable terminal apparatus 20.

The control apparatus 10 controls the wearable terminal apparatus 20, performs confirmation and determination for each of tasks performed, based on image data (still image data and movie data) acquired by the wearable terminal apparatus 20, and performs operation control such as task recording (evidence recording).

For such purpose, the control apparatus 10 includes, e.g., a control section 11, a communication section 12, a database 13, an evidence recording section 14, a display section 15 and a clock section 16.

In addition to the components stated above, the control apparatus 10 according to the present embodiment includes various components included in a general control apparatus, for example, an operation section although illustration of such components are omitted. Various components, illustration of which are omitted here, are parts that are not directly related to the present invention and thus detailed description of such components will be omitted.

The control section 11 is a component section including a plurality of control circuits, etc., configured to perform overall control of the entire work support system 1 according to the present embodiment. The plural control circuits, etc., included in the control section 11 specifically include, e.g., a work determining section 11a, a display control section 11b, a guide section 11c, an object determining section 11d, a size determining section 11e and a falsification preventing section 11f.

The work determining section 11a is a component section including, e.g., a control circuit configured to, based on, e.g., image data acquired by the wearable terminal apparatus 20, information accumulated in advance in the database 13 and determination result information acquired by the object determining section 11d and the size determining section 11e, perform, e.g., confirmation or determination for each of items relating to work performed. Examples of the determinations performed here include, e.g., determination of a type of a tool to be used for work and determination of a type of each task.

The display control section 11b is a component section including, e.g., a control circuit for controlling, e.g., the display section 15 included in the control apparatus 10 or a display section 25 included in the wearable terminal apparatus 20, the display section 25 operating in cooperation with the control apparatus 10, to provide predetermined display (e.g., warning display or guide display in addition to image display).

The guide section 11c is a component section including, e.g., a control circuit configured to, based on image data acquired by the wearable terminal apparatus 20 and information accumulated in advance in the database 13, create guide information for providing, e.g., guide display relating to work performed or guide display for a task to be performed next.

The object determining section 11d and the size determining section 11e are component section including, e.g., control circuits configured to, based on image data acquired by the wearable terminal apparatus 20 and information accumulated in advance in the database 13, detect and determine predetermined conditions such as a type, a part, a shape, a size, a number and/or a state of a predetermined object included in the image data. As a size determining method other than the aforementioned method, for example, use of a method in which a size of an object, an image of which is formed on a light-receiving surface of an image pickup device, is calculated using an autofocus mechanism, based on a relationship between a distance between the relevant image pickup apparatus and the object and a size of the image pickup device, is conceivable.

The falsification preventing section 11f is a processing circuit section for, e.g., protecting, and preventing falsification of, image data generated and recorded in the wearable terminal apparatus 20 (image pickup apparatus) and transferred to the control apparatus 10 via communication sections (22, 12), by subjecting the image data to particular data processing.

For example, the falsification preventing section 11f is a circuit section configured to subject image data recorded by the wearable terminal apparatus 20 and transferred to the control apparatus 10 to, e.g., particular data processing for permitting reproduction of the image data only if a particular image display apparatus or dedicated application software is used.

In addition to the data processing such as above, the falsification preventing section 11f performs, for example, data encryption processing and falsification detection hush function creation processing and other data processing such as file format conversion processing and data locking processing. For a technique for preventing falsification of data recorded on a recording medium, a conventionally well-known technique is used and thus further detailed description of such technique will be omitted.

The communication section 12 is a transmission/reception section including, e.g., a control circuit configured to perform data communication with (information transmission/reception to/from) the communication section 22 of the wearable terminal apparatus 20. Here, the communication section 12 may have a configuration using wireless communication or may have a configuration using wired communication.

The database 13 is a storage apparatus (auxiliary storage apparatus) configured to accumulate various kinds of information determined in advance. In the present embodiment, an example in which the database 13 is included in the control apparatus 10 (more specifically, for example, an internally-fixed recording medium (e.g., a built-in memory) or a removable recording medium (e.g., a removable card-type memory)). However, a configuration of the database 13 is not limited to these forms. For example, the database may be configured by an external storage apparatus having an independent form. In this case, a configuration in which various types of data can be transmitted/received by predetermined wireless or wired connection means may be provided between the database configured independently and the control apparatus 10.

The database 13 includes, for example, a work information database 13a and an image database 13b. Here, the work information database 13a contains work information including various kinds of information relating to a plurality of types of work. Here, work information includes individual pieces of detailed information relating to each type of work such as work names (e.g., a general name/process names/detailed task names), a work object, work parts, work time information (e.g., start/end times and/or a total length of time), surrounding environment information (e.g., work location/building name/room name/workbench position) and an operator name.

Such work information can be broken down to a plurality of processes included in each type of work. Furthermore, each process is detected as a work content (work element) that can be confirmed via an image, which enables checking or ensuring reliability of the work.

Reliability of each process or each task is determined by confirming whether or not each work element matches a content of an actual picked-up image of a task corresponding to the work element, details of which will be described later. Each work element is information that is not separate from information of a relevant process but information included in the information of the relevant process.

Each work content represented by work information is a collection of “work elements” resulting from the work content being broken down into objects or movements that can easily be determined based on results of image pickup by the image pickup apparatus (image data). Inclusion of such plural “work elements” in the database enables breaking down image determination into simple processes.

In other words, clearing each of these work elements (that is, if a result of determination is OK) enables determining whether or not each process is properly being performed or properly providing guide display such as advice related to each process at a proper timing Whether or not acquired images are images of respective relevant processes can be determined. Furthermore, if determinations that respective processes have properly been performed (results of “OK”) can be made in a particular order, the work to be recorded can be ensured in total. For, e.g., determination before and after a task, the work element information may be used as necessary.

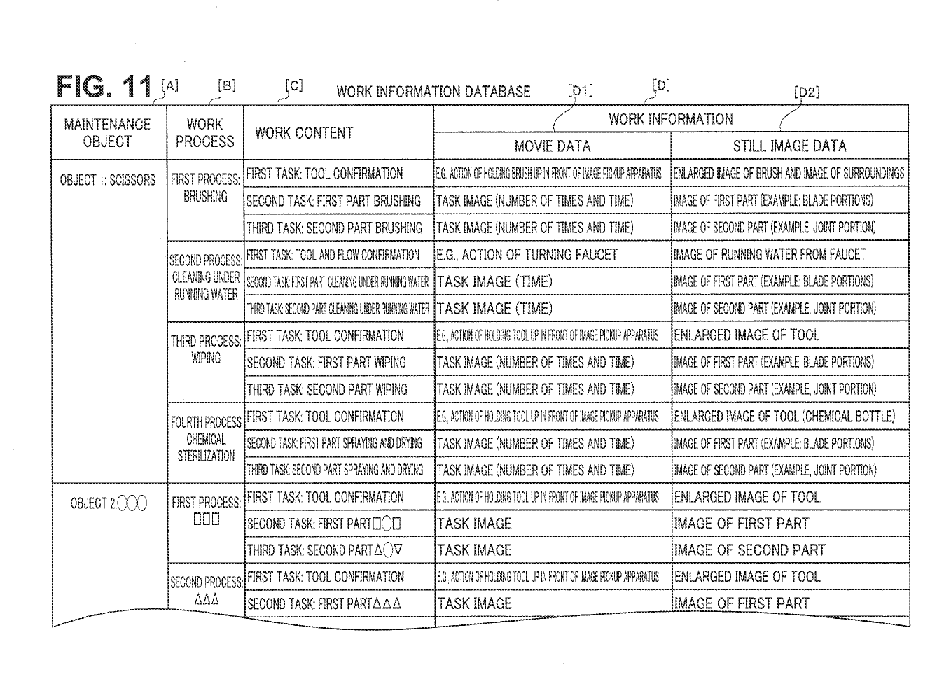

The image database 13b is a collection of image data related to various kinds of information recorded in the work information database 13a (for example, image information of images relating to a plurality of tasks from a plurality of field of views) (details will be described later; see FIG. 11).

The evidence recording section 14 is a component section including a control circuit or the like and a recording medium or the like configured to record, e.g., image data acquired by, e.g., the wearable terminal apparatus 20 and work information related to the image data, in association with each other. Images from more fields, ranges and points of views may be made available for reference.

The display section 15 is a component unit including, e.g., a display panel and a drive circuit for the display panel, the display panel and the drive circuit being capable of displaying a screen for various settings, displaying, e.g., image data recorded in the evidence recording section 14 or image data transferred from the wearable terminal apparatus 20, and displaying, e.g., various kinds of information (meta data) accompanying image data that is being displayed.

The clock section 16 is an internal clock called “real-time clock (RTC)”. The clock section 16 is a circuit section used for, for example, providing date information and time information to, e.g., a data file, timing an interval between predetermined instruction timings during control processing, and temporal control.

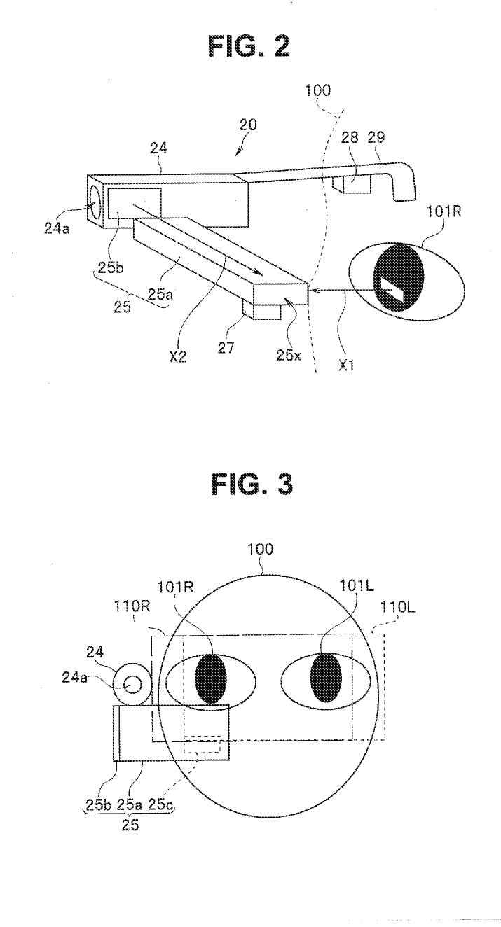

The wearable terminal apparatus 20 is, for example, as illustrated in FIG. 2, an image pickup apparatus of a type in which an operator can wear the image pickup apparatus on a part of his/her body (for example, the vicinity of the face) to have both hands free and an image of conditions in the vicinity of the hands of the operator himself/herself can consistently be picked up.

In other words, the wearable terminal apparatus 20 is an image pickup apparatus of a type that enables acquisition of work information corresponding to the operator's visual line. In other words, an image displayed based on image data acquired by the wearable terminal apparatus 20 can be used as evidence of the operator viewing such a scene.

The wearable terminal apparatus 20 not only mainly acquires movie data, but also acquires still image data at an arbitrary timing. Movie data acquired by the wearable terminal apparatus 20 is used to grasp, e.g., a flow of successive tasks performed by an operator and passage of time consumed for the tasks and record such time data, etc., as evidence information. In the case of still image data, the still image data may be of a type with information based on which temporal change can be determined, for example, data information representing a temporal change of an image such as a motion vector, added. When the still image data is used as evidence information, it is preferable that the still image data be still image data that can be verified later by a human being.

Such images have an advantage of good searchability when the image is displayed or printed because of the image having a large amount of information and an advantage of easiness of finding a falsification. Linking various kinds of information to image data enables enhancement in significance and value of the image and further enables the image data to be treated as evidence or a trail. An image has a large amount of information and thus is effective for trail information recording for determination of a particular situation, with an image determination function and image recording brought in cooperation with each other.

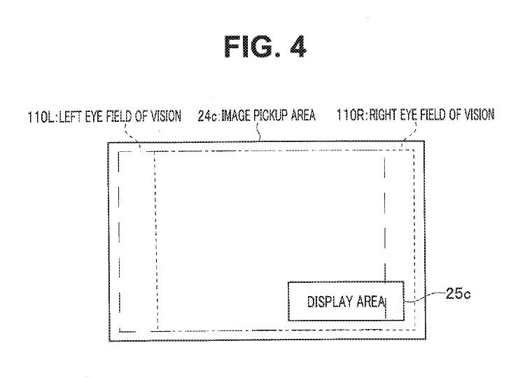

Here, FIG. 2 is a conceptual diagram illustrating a schematic configuration of an image pickup apparatus (wearable terminal apparatus) forming a part of the work support system according to the present embodiment. The illustration in FIG. 2 is premised on a state in which an operator wears the image pickup apparatus (wearable terminal apparatus). FIG. 3 illustrates the face of the operator when the operator wears the image pickup apparatus (wearable terminal apparatus) as viewed from the front and is a conceptual diagram illustrating a range of vision of the operator's both eyes. FIG. 4 is a conceptual diagram illustrating the range of vision of the operator's both eyes illustrated in FIG. 3 in more detail.

In the present embodiment, the wearable terminal apparatus 20 is an image pickup apparatus configured to operate alone under the control of the control section 21 and also operates under the control of the control section 11 of the control apparatus 10 via communication with the control apparatus 10.

In addition to movie data acquisition, the wearable terminal apparatus 20 in the present embodiment has, for example, a function that can arbitrarily or automatically acquire still image data simultaneously with movie data or still image data alone with a predetermined operation or a predetermined action performed by an operator as a trigger.

The wearable terminal apparatus 20 includes, e.g., the control section 21, the communication section 22, an operation section 23, an image pickup section 24, the display section 25, a recording section 26 (not illustrated in FIG. 3; see FIG. 2), a voice input section 27, a voice output section 28 and a support portion 29 (not illustrated in FIG. 2; see FIG. 3).

The control section 21 is a component section including, e.g., a control circuit configured to perform overall control of the entire wearable terminal apparatus 20. The control section 21 is configured by, for example, a processor using, e.g., a central processing unit (CPU). The control section 21 operates according to programs stored in a memory (not illustrated) to perform control of the respective component sections.

In other words, the control section 21 controls the communication section 22 to perform control to transmit/receive various kinds of information to/from (communicate with) the control apparatus 10. The control section 21 performs control of the respective component sections in response to an operation input from the operation section 23. The control section 21 controls the image pickup section 24 to perform control to acquire, e.g., image data. The control section 21 controls the display section 25 to perform control to display various kinds of information on a screen of a display panel 25b (described later; see FIG. 2). Upon receipt of an output (picked-up image data) from the image pickup section 24, the control section 21 controls the recording section 26 to perform control to subject the received image data to predetermined signal processing and record the image data subjected to the processing in a recording medium included in the recording section 26. The control section 21 controls the voice input section 27 to perform control to, upon receipt of an input of voice information, generate a predetermined instruction signal. The control section 21 controls the voice output section 28 to perform control to output, e.g., voice guide information or a voice warning instruction.

In addition to these types of control, the control section 21 controls the wearable terminal apparatus 20 in cooperation with the control apparatus 10 upon receipt of a control signal from the control section 11 of the control apparatus 10.

The control section 21 includes, e.g., a plurality of circuit sections, for example, an image determining section 21b and a display control section 21c.

The image determining section 21b is a determination processing circuit configured to perform predetermined determination based on image data acquired by the image pickup section 24. The image determining section 21b is a circuit section that is equivalent to or simpler than various determination sections (11a, 11d, 11 e) included in the control section 11 of the control apparatus 10 described above.

In other words, the image determining section 21b functions as a work determining section configured to determine a work content in image data (still image data or movie data) acquired by the image pickup section 24, based on work information in the database 13. Therefore, if various determination sections (11a, 11d, 11 e) are provided in the control section 11 of the control apparatus 10, the image determining section 21b can be omitted.

Here, if the image determining section 21b is provided on the wearable terminal apparatus 20 side, a result of determination by the image determining section 21b alone may be transmitted to the control section 11 of the control apparatus 10 via the communication sections (22, 12). Upon receipt of such determination result, the control section 11 of the control apparatus 10 performs control based on the received determination result information. Therefore, this configuration has an advantage of enabling communication load reduction.

The display control section 21c is a control circuit section for controlling the display section 25 to provide predetermined display on the display panel 25b (see FIG. 2).

The communication section 22 is a transmission and reception section including, e.g., a control circuit configured to control communication with (information transmission/reception to/from) the control apparatus 10. For the communication section 22, wireless or wired predetermined communication means is employed.

Furthermore, the communication section 22 can communicate with the database 13 via the control apparatus 10 and refer to work information in the database 13. A configuration in which the communication section 22 and the database 13 directly communicate with each other may be employed.

The operation section 23 is a component section including, e.g., a plurality of operation members for operating the wearable terminal apparatus 20 and a plurality of electric components corresponding to the plurality of operation members, the plurality of electric components being configured to generate respective predetermined operation input signals (detailed configuration of the operation section 23 is not illustrated).

The image pickup section 24 is a component section including, e.g., an image pickup optical system 24a (see FIG. 2), a non-illustrated image pickup device and a drive control circuit for the image pickup device. The image pickup section 24 has a function that sequentially performs photoelectric conversion of optical images of an image pickup object, the optical images being formed by the image pickup optical system 24a, via the image pickup device and sequentially causes images, based on image data obtained as a result of the photoelectric conversion, to be displayed on the display panel 25b of the display section 25. The image pickup section 24 also has a function that, e.g., forms a predetermined type of image data (for example, movie data or still image data) based on an obtained image signal and records the image data and transmits the image data to the control apparatus 10 via the communication sections 22, 12. A configuration of the image pickup section 24 itself with such functions is substantially similar to a configuration of an image pickup section in a conventional general image pickup apparatus. Therefore, detailed description and illustration of the configuration of the image pickup section 24 are omitted.

For the image pickup device, for example, a photoelectric conversion element such as a CCD (charge-coupled device) image sensor or a CMOS (complementary metal-oxide semiconductor)-type image sensor is employed. Such an image pickup section as above can provide an image close to an operator's visual line (range of vision or field of vision) during work and thus makes it easy to confirm detailed tasks using both hands (including visual check).

The display section 25 is a component section including, e.g., a display control circuit configured to, in addition to displaying an image based on image data acquired by the image pickup section 24, be capable of displaying various warnings or various predetermined messages or guides (details will be described later), etc., in such a manner that such warnings or predetermined messages or guides, etc., are superimposed on the image, and displays, e.g., a menu for various settings, etc., for the wearable terminal apparatus 20 by appropriately switching to a predetermined operation mode.

The display section 25 includes, e.g., a light guiding section 25a and the display panel 25b. The display panel 25b is a component section including, e.g., a display screen for providing various types of display and a display control circuit for achieving such display. For the display panel 25b, for example, a liquid-crystal display (LCD) section or an organic electroluminescence (organic EL or OEL) display section is employed.

The light guiding section 25a is a component section configured to guide an image displayed on the display panel 25b to a predetermined display surface.

Here, as illustrated in FIG. 2, the display panel 25b in the wearable terminal apparatus 20 according to the present embodiment is installed so as to, for example, face in a direction that is different from a plane facing in a direction of the operator's visual line (arrow X1 direction in FIG. 2).

More specifically, for example, in FIG. 2, arrow X1 denotes the direction of the operator's visual line, and arrow X2 denotes the direction in which a display surface of the display panel 25b faces. In this case, a long axis direction of the light guiding section 25a is provided so as to correspond to the arrow X2 direction in FIG. 2. Therefore, light forming an image on the display surface of the display panel 25b is guided in the arrow X2 direction by the light guiding section 25a.

Inside the light guiding section 25a, a light refracting member (prism or the like) configured to refract and guide light guided in the arrow X2 direction by the light guiding section 25a in the arrow X1 direction is disposed at an end portion (see reference numeral 25x). Therefore, light emitted from the display surface of the display panel 25b is guided in the arrow X2 direction by the light guiding section 25a and displayed at a position that can be viewed by one of the eyes of the operator (see reference numeral 25c in FIG. 3), via the prism or the like.

The voice input section 27 is a component section including, e.g., an electric component configured to receive an input of voice information and a drive circuit configured to drive the electric component. The voice input section 27 is controlled by the control section 21 so as to collect voice information in a surrounding environment at a predetermined timing. For the voice input section 27, for example, a microphone is employed. More specifically, for example, the voice input section 27 is configured to generate a predetermined instruction signal upon receipt of the operator's voice instruction. In other words, the wearable terminal apparatus 20 is configured to be capable of treating voice inputted from the voice input section 27 as an operation command. Therefore, in this case, the voice input section 27 functions as operation means for performing a predetermined operation.

For an arrangement of the voice input section 27, for example, it is desirable that the voice input section 27 be arranged in the vicinity of the mouth of the operator (see FIG. 2) when the operator wears the wearable terminal apparatus 20. Such arrangement enables the operator to reliably perform a voice input to the voice input section 27.

The voice output section 28 is a component section including, e.g., an electric component configured to output voice information and a drive circuit configured to drive the electric component. The voice output section 28 is controlled by the control section 21 to output voice information (for example, voice information such as a warning or a message, or a voice guide) at a predetermined timing. For the voice output section 28, for example, a sound generating apparatus such as a speaker is employed.

As an arrangement of the voice output section 28, for example, it is desirable that the voice output section 28 be arranged in the vicinity of the operator’ ear (see FIG. 2) when the operator wears the wearable terminal apparatus 20. Such arrangement enables the operator to reliably catch a voice outputted from the voice output section 28.

The support portion 29 (see FIG. 2) is a frame member that assembles the respective component sections of the wearable terminal apparatus 20, the frame member being configured to be wearable on a part of the body (for example, the vicinity of the face) of the operator. The example configuration of the support portion 29 illustrated in FIG. 2 is an example in which the support portion 29 is configured in what is called an eyeglass-like shape.

For the voice output section 28, in addition to the function that outputs voice information, an electric component having a function that generates vibration may further be employed. In this case, at the time of an output of voice information, vibration of a predetermined cycle is generated, enabling a warning to the operator to be more clearly transmitted. The cycle of the vibration is changed according to the type of the warning, enabling vibration to be generated according to each of a plurality of types of warnings. A vibration generating section may be provided as an independent component.

Although not illustrated, the wearable terminal apparatus 20 according to the present embodiment includes a battery that serves as a power supply source. The battery generates power necessary for driving the wearable terminal apparatus 20 and supplies the power to the respective component sections under the control of the control section 21.

The wearable terminal apparatus 20 also includes the clock section 20a (see FIG. 2) inside. As with the clock section 16 in the control apparatus 10 above, the clock section 20a is an internal clock that is so-called real-time clock (RTC). The clock section 20a is also a circuit section used for, for example, providing date information and time information to, e.g., a data file, and predetermined timing processing such as temporal control.

Other components, illustration and description of which have been omitted, are equivalent to relevant components in a conventional general image pickup apparatus configured to be capable of acquiring image data.

A manner in which an operator wears the wearable terminal apparatus 20 configured as above is, for example, as illustrated in FIGS. 2 and 3.

In FIGS. 2 and 3, reference numeral 101R denotes the right eye of the operator 100 and reference numeral 101L denotes the left eye of the operator 100. In FIG. 3, the reference numeral 110R denotes the right eye field of vision for the right eye 101R and reference numeral 110L denotes the left eye field of vision for the left eye 101L.

In this case, it is assumed that the operator 100 wears the support portion 29 of the wearable terminal apparatus 20, for example, in the vicinity of the right ear (for the operator 100 himself/herself).

As described above, when an operator wears the wearable terminal apparatus 20, the image pickup optical system 24a of the image pickup section 24 is directed in a direction that substantially corresponds to the direction of the operator's visual line (arrow X1 direction). When the operator 100 wears the wearable terminal apparatus 20 and changes the direction of the visual line by, e.g., turning his/her head, the direction in which the image pickup optical system 24a of the image pickup section 24 faces is also changed so as to follow the change of the visual line. Therefore, image data acquired by the image pickup section 24 when the operator 100 wears the wearable terminal apparatus 20 is image data of a predetermined area including a direction in which the operator looks (direction of the visual line). Here, an image pickup area for image data acquired by the image pickup section 24 is the frame line indicated by reference numeral 24c in FIG. 4. The image pickup area 24c can arbitrarily be set according to an angle of view of the image pickup optical system 24a. In the present embodiment, the image pickup area 24c is set so as to be an area including the operator 100's right eye field of vision 110R and left eye field of vision 110L.

Furthermore, in a state in which the operator 100 wears the wearable terminal apparatus 20, display on the display panel 25b of the display section 25 is provided in the predetermined area indicated by the reference numeral 25c in FIGS. 3 and 4 within the operator 100's right eye field of vision 110R via the light guiding section 25a. The display area 25c is an area in a part of the whole field of vision of the operator 100's both eyes (110R, 110L) to the extent that the area does not impair the operator 100's field of vision, the area having a viewable form. In a normal state, the operator 100 can view both right and left eyes' field of vision (110R, 110L), and can watch the display area 25c and view the content of display on the display section 25 by moving the visual line.

Although the display area 25c is illustrated in such a manner that the display area 25c is included within the left eye's field of vision 110L in FIGS. 3 and 4, since the display area 25c is arranged at a position that is very close to the operator's right eye 101R, the display area 25c can actually be viewed by the right eye 101R only, and the display area 25c does not fall within the left eye's field of vision 110L (can hardly be viewed by the left eye).

Operation of the work support system 1 according to the present embodiment configured as above will be described below.

Although various types of work in various fields can be assumed as work performed using the work support system 1 according to the present embodiment, the below description will be provided as a specific example of work taking, as an example, maintenance work relating to, e.g., cleaning a predetermined medical instrument or the like from among types of work of treating a medical instrument or the like. More specifically, work for cleaning and sterilizing a surgical instrument or a treatment instrument, which is a used medical instrument (for example, an instrument having a shape of scissors; hereinafter abbreviated as “scissors”) (hereinafter referred to as “instrument cleaning/sterilizing work”) is described as an example.

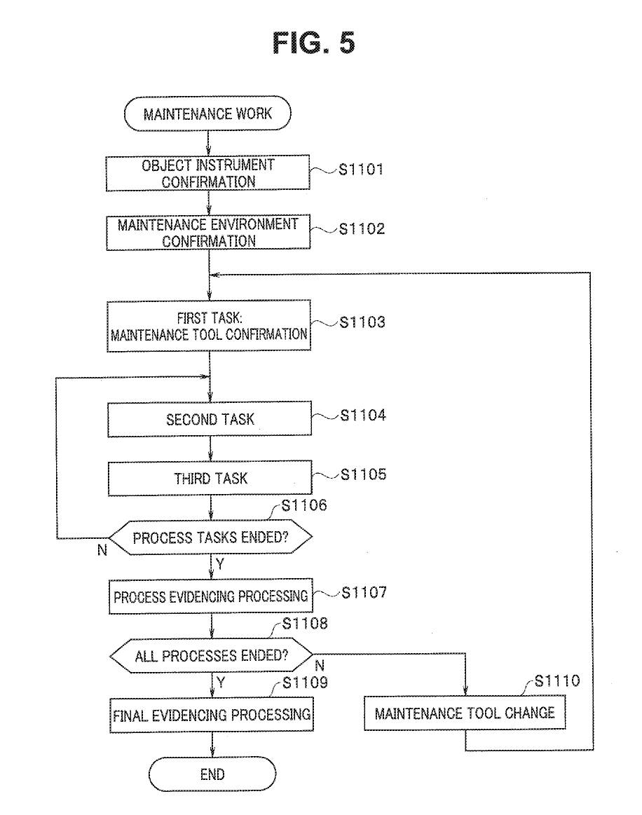

First, a schematic flow of instrument cleaning/sterilizing work generally performed will briefly be described with reference to the flowchart in FIG. 5. FIG. 5 is a flowchart illustrating a flow of tasks to be performed by an operator in medical instrument maintenance work (instrument cleaning/sterilizing work).

As illustrated in FIG. 5, first, in step S1101, an operator confirms an object (instrument) to be subjected to maintenance work (for example, visual confirmation) in normal instrument cleaning/sterilizing work.

Subsequently, in step S1102, the operator confirms a state of a maintenance environment. Here, a maintenance environment refers to an environment of a site (e.g., a room or a table) for performing the work. Confirmation of a state of an environment refers to confirmation of whether or not the environment is in a clean state, that is, whether or not the environment is suitable for cleaning/sterilizing work. In a normal case, a dedicated maintenance environment (e.g., a room or a table) is provided.

Subsequently, in step S1103, the operator performs a first task in a first process of the maintenance work.

Here, it is assumed that maintenance work is considered as sequential work to be completed by performing a plurality of processes each including a plurality of tasks. In other words, predetermined maintenance work is completed by performing a plurality of work processes in a predetermined procedure. Each of the plurality of work processes further includes a plurality of specific task actions, and each work process is completed by performing a plurality of relevant tasks in a predetermined procedure.

In step S1103, the first task in the first process is, for example, a task of confirming a maintenance tool. Here, a maintenance tool is, for example, a cleaning brush for cleaning instruments. In this case, a plurality of types of cleaning brushes are provided as maintenance tools. It is necessary that tools be provided for respective object parts of predetermined instruments so as to be optimum for the respective maintenance object instruments and that tools optimum for respective processes and respective tasks in maintenance work be selected. Therefore, before each task, it is necessary to confirm a tool to be used.

Here, at a timing of the operator confirming a tool to be used, an image of the tool to be used is automatically acquired as evidence information. Accompanying information such as time information of a task start timing is recorded at the same time. Here, the accompanying information is recorded as accompanying information attached to image data, for example, meta data in an image file format such as Exif (exchangeable image file format). Furthermore, e.g., a task of the operator looking around to acquire image data of a work environment may be included.

Next, in step S1104, the operator performs a second task in the first process. The second task is, for example, a task of cleaning a predetermined first part (specific part, for example, blade portions of scissors) of the maintenance object instrument, but a specific example will be omitted. At this timing, a movie during the task is automatically acquired as evidence information. A still image may be acquired at a predetermined timing in this case too. Simultaneously, accompanying information such as time information (e.g., task start time and completion time or a total task time period) is also recorded. Such accompanying information, etc., may be recorded in such a manner that the pieces of accompanying information, etc., is added to the acquired movie data or the still image data in the same file.

Subsequently, in step S1105, the operator performs a third task in the first process. As in the above, the third task is, for example, a task of cleaning a predetermined second part (specific part, for example, a joint portion of the scissors) that is different from the first part of the cleaning maintenance object instrument, but a specific example of third task will be omitted. Here, evidence information similar to the above (image data and various accompanying information, etc.) are also recorded.

In the next step S1106, whether or not a plurality of tasks prescribed in the first process have ended is confirmed. In the work example illustrated in the flowchart in FIG. 5, the first process is completed by the first to third tasks.

Therefore, if it is determined at that point of time that the tasks in the first process have not ended, the work returns to the processing in step S1104 and processing that is similar to the above is repeated. Upon completion of all the tasks in the first process being confirmed, the work proceeds to processing in the next step S1107.

Next, in step S1107, process evidencing processing for each of the tasks in the first process is performed. Here, process evidencing processing is a task of the operator confirming completion of each of the tasks in the first process and clearly indicating the confirmation as evidence. Specific examples of such task include, e.g., a checklist for, for each of task items to be confirmed, the task items being listed in advance for each task, confirming and recording whether or not the operator has performed the task.

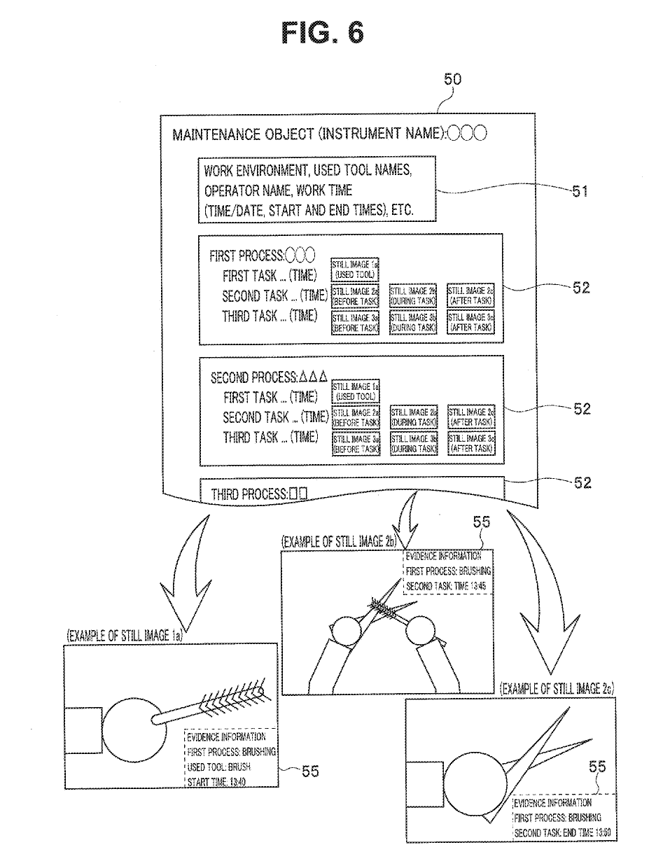

For image data and various accompanying data, etc., acquired as evidence information in each of the tasks in the relevant process, processing for organization, such as associating the individual pieces of information with the respective tasks, and recording the resulting pieces of information is performed (see FIG. 6).

Next, in step S1108, whether or not all the work processes in the relevant maintenance work (instrument cleaning/sterilizing work) has ended is confirmed. Here, if it is confirmed that all the work processes have not ended, the work proceeds to processing in step S1110. If it is confirmed that all the work processes have ended, the work proceeds to processing in the next step S1109.

In step S1110, the operator performs a task of changing the maintenance tool currently in hand to a maintenance tool to be used for the next work process. Then, the work proceeds to the processing in step S1103 above.

On the other hand, if it is confirmed that all the work processes have ended the operator performs final evidencing processing for the relevant maintenance work (instrument cleaning/sterilizing work) in step S1109. Here, final evidencing processing is, for example, a task of compiling the checklists created for the respective processes in the relevant work and creating a comprehensive and final work checklist and creating an evidence information file of the comprehensive and final work checklist. In other words, the final evidencing processing is processing for compiling the pieces of evidence information for the respective processes, the pieces of evidence information being created in the processing (process evidencing processing) in step S1107 above, and filing the evidence information for the relevant work.

The evidence information file is, for example, as illustrated in FIG. 6, a document having a list form in which a plurality of pieces of information are compiled in a predetermined format. The evidence information file may be, for example, a type of document printed on a paper sheet or what is called an electronic file having an electronic form. FIG. 6 is a diagram illustrating an example of an evidence information file created in maintenance work.

An evidence information file 50 is, for example, a data collection having a list form in which, e.g., information on a maintenance object instrument (index information), a plurality of work processes 52 determined for the maintenance object instrument, and information on contents of a plurality of tasks performed in each work process 52, and a plurality of confirmation items according to the respective contents of the tasks are listed.

A plurality of confirmation items 51 included in the evidence information file 50 include, for example, as illustrated in FIG. 6, a surrounding environment in which the work was performed (for example, an operation room or an operation table), names of tools used for the work, the operator's name, work time (time/date, start/end times). The plurality of confirmation items are determined in advance for each of a plurality of tasks in each work process 52. In addition to the confirmation item list, a plurality of image (still image or movie) data acquired in each task is recorded as pieces of evidence information, and corresponding image data, etc., are recorded in association with the respective confirmation items.

Conventionally, a plurality of corresponding image data are acquired for the image data, etc., recorded as pieces of evidence information at the time of completion of each task in sequential work or, for example, at a plurality of timings such as a timing immediately before start of each task, a predetermined timing during the task and a timing of completion of the task. These image data are conventionally acquired by manual operation performed by an operator. The work support system 1 according to the present embodiment is configured so that various kinds of evidence information including these image data, etc., are automatically recorded.

Furthermore, in this case, the work support system 1 according to the present embodiment is configured so that various kinds of evidence information related to image data are automatically recorded, as accompanying information, in a predetermined area in the image data. For example, for an image data file acquired during a task in a predetermined process of predetermined work, accompanying information related to the image data, for example, meta data in an image file format such as Exif (exchangeable image file format) (reference numeral 55 in FIG. 6), is recorded integrally or as a separate file (see FIG. 6). In FIG. 6, for the sake of convenience, a form in which a part of a content of meta data is displayed in an image is illustrated, but the present invention is not limited to this form. Meta data only needs to be information accompanying an image data file, various forms are conceivable for a form of meta data and any of such forms may be employed.

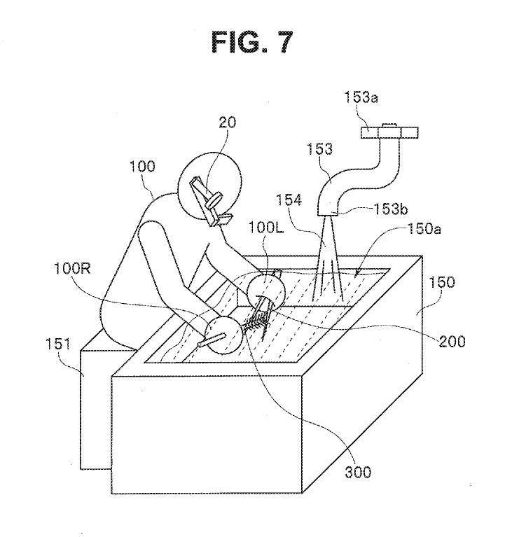

Next, operation of use of the work support system 1 according to the present embodiment will be described below. FIG. 7 is a conceptual diagram illustrating how predetermined maintenance work (instrument cleaning/sterilizing work) is performed using the work support system according to the present embodiment.

As illustrated in FIG. 7, when maintenance work (instrument cleaning/sterilizing work) described as an example in the present embodiment is performed, an operator 100 performs the work in a state in which the operator 100 sits on a chair 151 and faces a workbench 150 installed in a predetermined work room. At this time, the operator 100 wears the wearable terminal apparatus 20 in the vicinity of his/her face. Consequently, the wearable terminal apparatus 20 acquires image data of a predetermined area including a direction of the operator 100's visual line.

Here, illustration of the image pickup apparatus (wearable terminal apparatus 20) that operates in cooperation with the control apparatus 10 is omitted in FIG. 7. This is because a work site for the work described as an example in the present embodiment is located in the vicinity of a water facility and thus the control apparatus 10 is installed at a remote site.

The maintenance work (instrument cleaning/sterilizing work) described as an example here is work of cleaning and sterilizing scissors 200, which are a used medical instrument, treatment instrument or the like. Therefore, the workbench 150 includes a cleaning basin 150a. A water faucet 153 is installed above the cleaning basin 150a. When a handle 153a of the water faucet 153 is turned in an opening direction, running water 154 flows out from an outlet 153b.

In FIG. 7, the part indicated by dotted shading indicates a pool of a cleaning liquid such as water in the cleaning basin 150a. Brushing, etc., of an instrument is mainly performed in the cleaning liquid such as water held in the cleaning basin 150a.

The operator 100 brushes and thus cleans a maintenance object instrument (scissors 200) in the cleaning liquid (for example, water) held in the cleaning basin 150a, using a predetermined tool (cleaning brush 300).

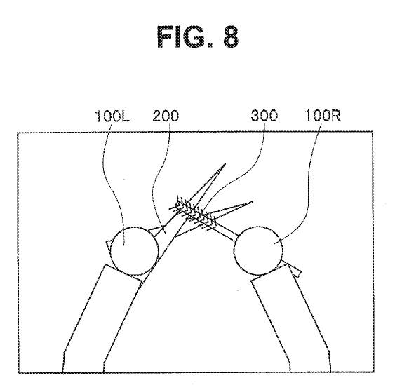

In this case, image data acquired by the wearable terminal apparatus 20 is, for example, the image illustrated in FIG. 8. FIG. 8 illustrates an example of display of an image based on image data acquired by the wearable terminal apparatus during a task in maintenance work (instrument cleaning/sterilizing work) using the work support system according to the present embodiment.

In the example image display illustrated in FIG. 8, how the operator 100 performs brushing and cleaning work with a maintenance object instrument (scissors 200) in one hand (left hand 100L), using a predetermined tool (cleaning brush 300) in the other hand (right hand 100R) is described. At this time, the wearable terminal apparatus 20 picks up an image of an area in the vicinity of the operator 100's hands.

Next, operation when predetermined maintenance work (instrument cleaning/sterilizing work) is performed using the work support system 1 according to the present embodiment will be described below.

As described above, the work support system 1 according to the present embodiment is a system configured to, when an operator 100 performs predetermined work, operate with the image pickup apparatus (wearable terminal apparatus 20) and the control apparatus 10 in cooperation with each other.

Here, an outline of operation of the work support system 1 according to the present embodiment will briefly be described as follows.

In the work support system 1 according to the present embodiment, the image pickup apparatus (wearable terminal apparatus 20) arbitrarily picks up images of states of a plurality of tasks sequentially performed by an operator. The respective image data thus acquired are transmitted to the control apparatus 10.

The control apparatus 10 receives the image data acquired by the wearable terminal apparatus 20 and performs predetermined determination processing based on the image data, etc., and various kinds of information accumulated in advance in the database. Here, the determination processing performed by the control apparatus 10 includes, for example, determinations of a plurality of confirmation items prescribed according to the content of the relevant work, for example, determination of a maintenance object instrument, determination of, e.g., a type of a tool to be used, and determination of, e.g. task actions (e.g., brushing, water cleaning, wiping and chemical spraying).

Then, the control apparatus 10 performs various types of control processing based on results of the determination processing. For example, if a task action performed matches a prescribed task (is a correct task), e.g., a confirmation check table is created and in addition, evidence recording is performed. The evidence recording is, for example, processing for recording evidence information to be included in an evidence information file, which is illustrated in FIG. 6.

For example, if a result of the determination is that a task action performed deviates from a prescribed task (is an erroneous task), e.g., a warning to such effect is displayed and e.g., a guide for performing the task correctly again is displayed.

Furthermore, the control apparatus 10 receives image data from the wearable terminal apparatus 20 and performs processing for adding various kinds of corresponding evidence information to the image data, and as necessary, performs various types of data processing such as predetermined falsification prevention processing.

FIG. 11 illustrates an example of specific information contents included in the work information database 13a. The example illustrated in FIG. 11 is an example of a database assuming maintenance work for cleaning “scissors”, which are a type of instrument used for surgery, treatment or the like, by means of manual operation by an operator after use in surgery, treatment or the like (hereinafter abbreviated as “scissors cleaning/sterilizing work”).

As illustrated in FIG. 11, in the work information database, maintenance object column [A] indicates a name of a maintenance object tool. In the present example, “Object 1: scissors” is recorded and thus indicates scissors cleaning/sterilizing work. Another instrument name is recorded in “Object 2: xxx”, but here (FIG. 11), detailed illustration of examples other than information on “Object 1” is omitted. Although illustration of fields following “Object 2” is omitted in the work information database in FIG. 11, items “Object 3”, “Object 4” . . . follow “Object 2”.

In the work information database in FIG. 11, work process column [B] indicates a list of a plurality of example work processes included in the maintenance work in an order of processes. Here, work processes included in scissors cleaning/sterilizing work are: for example,

“First process: brushing” process;

“Second process: cleaning under running water” process;

“Third process: wiping” process; and

“Fourth process: chemical sterilization” process.

The “First process: brushing” process is a process of brushing in, e.g., a predetermined basin using a predetermined tool (e.g., a brush).

The “Second process: cleaning under running water” process is a process of cleaning under running water.

The “Third process: wiping” process is a process of wiping off water and dirt using a predetermined tool (e.g., paper or cloth).

The “Fourth process: chemical sterilization” process is a process of sterilization by using (spraying) a predetermined chemical (e.g., alcohol).

Here, “scissors cleaning/sterilizing work” is described as an example. Therefore, types and numbers of processes to be performed differ depending on the object instrument.

In the work information database in FIG. 11, work content column [C] provides a list of examples of a plurality of tasks included in each work process in the order of tasks to be performed.

Here, examples of tasks included in the “First process: brushing” process in the scissors cleaning/sterilizing work are:

“Tool confirmation” task as “First task”;

“First part brushing” task as “Second task”; and

“Second part brushing” task as “Third task”.

Specific information of each task is recorded in the next work information column “D”.

The above also indicates that each of such processes consists of simple tasks. Consequently, instructions given to an operator are simplified, what motion the operator needs to make for each task and which tool to be used for the task are clarified, the tasks are simplified, and monitoring and confirmation for the tasks can thus be performed by simple processing.

In other words, specific information clearly indicating each task (for example, text data and/or image data) is recorded in the work information database in FIG. 11, in work information column [D]. In FIG. 1, although the image database 13b is provided separately from the work information database 13a, the database 13 may have a form in which both the work information database 13a and the image database 13b are configured integrally.

As described above, the database 13 includes a plurality of pieces of process information managed chronologically and the operator may perform tasks in such order. As described above, as a result of process information acquisitions in which particular process information is acquired from particular work being sequentially performed, an operator can perform the work in a correct procedure. As a result of each process being broken down, individual simple tasks are provided as work contents, and thus even if an operator has no high skills or is not accustomed to the tasks or the process, the operator can reliably perform the work. The work contents can be called “confirmation work elements” resulting from the work being broken down to a level at which each work content can easily be determined objectively using images (still images and a movie).

Information in work information column [D] further includes movie data information [D1] obtained using the wearable terminal apparatus 20 and still image data information [D2].

The “Tool confirmation” task, which is “First task” included in the “First process: brushing” process is a task of confirming a tool to be used in the relevant work process. For that purpose, in work information [D], movie data in which an action of holding a tool (brush) up to a front face of the wearable terminal apparatus 20 (within an image pickup range) is recorded (for example, data called, e.g., motion data) is recorded as movie data information [D1]. In FIG. 11, the wearable terminal apparatus 20 is abbreviated as “image pickup apparatus”.

Still image data information [D2] includes, e.g., an enlarged image of the tool (brush) and an image of a surrounding environment of the operator 100 (stated “Image of surroundings” in FIG. 11). As an image of the surroundings, for example, information on, e.g., a work room, a workbench and work clothes of the operator 100 himself/herself is recorded in the form of data of, e.g., texts or an image.

Here, when the operator performs the “Tool confirmation” task, the following task is performed. In other words, first, the operator 100 performs an action of taking a predetermined tool (cleaning brush 300) to be used for the work to be performed from that time in his/her hand and holding the predetermined tool up to the front face of the wearable terminal apparatus 20. This action is recorded as movie data and recorded at the same time as still image data by the wearable terminal apparatus 20. For the “Tool confirmation” task, the operator 100 holds the predetermined tool (cleaning brush 300) in his/her right hand 100R up to the front face of the wearable terminal apparatus 20 (within the image pickup range). At this time, the wearable terminal apparatus 20 continues acquiring movie data from a point of time of start of the work and simultaneously acquires still image data at a predetermined timing (for example, at a timing of holding the tool to be used up to the front face of the wearable terminal apparatus 20 (within the image pickup range)).

Here, although for still image data, an example in which an image of a gesture that is a motion of holding the tool up is picked up is described, shooting may be performed via a particular operation section operation or a command similar to such operation given by the operator's voice using a voice recognition technique. Automatic shooting may be performed via a remote instruction or at a time at which the task should end. The image data thus obtained by the image pickup apparatus is information related to a task based on a piece of the process information chronologically managed in the work database and a result of the task, and thus, the control apparatus for the image pickup apparatus or the system records the image data acquired by the image pickup apparatus in the recording section, in association with meta data including the piece of process information corresponding to the image data, from among the pieces of work information acquired by the control apparatus, and shooting time information, as a trail of the task.

In this case, it is important that respective processes are classified chronologically in the database, and information on a length of time assumed for each process is stored in the form of data in the database, which enables detection of, e.g., a delay or a trouble in the work, a work mistake or a process skip. A result of the detection can also be read from the image data.

Here, a length of time taken for a task in a particular process may be calculated by a difference between a time at which a start of the task is shot and a time at which an end of the task is shot. Since the processes are managed chronologically, what situation has taken place in which process can be traced while visually comparing images related to the respective processes.

As described above, an effect that is different from an effect conventionally obtained by merely incorporating shooting time information into an image file can be obtained. In other words, whether or not respective processes of work have been performed in an assumed procedure can be determined via images. Verification capability of images can also be enhanced.

It should be understood that the “process” can be broken down into further work contents and a tool, a movement, a motion, etc., matching the work contents are determined and results of the determination may be associated with relevant image data, as meta data.

It is possible to determine, by images, whether or not actual task matches an expected work process (task confirmation). That is, the matching can be determined by breaking down a series of motions recorded in the picked-up images for each work process to the extent that the determination by the images is possible. In such a case, information on the results of such task confirmation, that is, desired result or not, for example, can be associated with the picked-up image data as meta data. Further, each task may be supervised, monitored, subjected to determination of whether or not the task is correct or documented using the relevant image by comparing an picked-up image and an image pickup object or a motion (work element) particular to the relevant work process.

An image of the action (action of holding the cleaning brush 300 up to the front face of the wearable terminal apparatus 20) performed by the operator 100 is picked up by the wearable terminal apparatus 20. At this time, the movie data and the still image data acquired by the wearable terminal apparatus 20 are continuously transferred to the control apparatus 10.

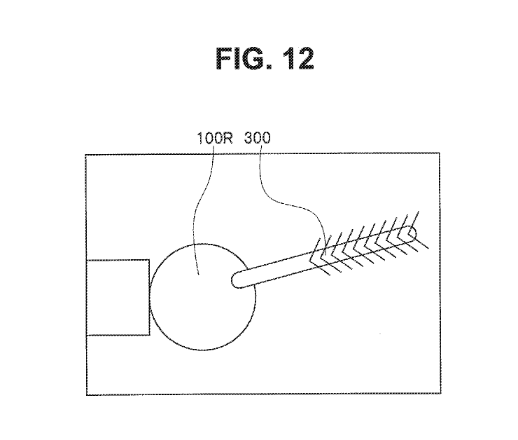

The control apparatus 10 performs predetermined image determination processing based on the received movie data. For example, upon detection of the prescribed action (action of holding the brush up), the control apparatus 10 controls the wearable terminal apparatus 20 to perform an operation of picking up still image data. Consequently, an enlarged image (still image) of the tool to be used (cleaning brush 300) is recorded. The still image acquired at this time is, for example, the image illustrated in FIG. 12. In other words, an enlarged image of an object (tool to be used) can be obtained by holding the object (tool to be used) up to a position that is relatively close to the front face of the image pickup apparatus (wearable terminal apparatus 20).

Furthermore, subsequently to or simultaneously with the above, the operator 100 performs an action of looking around the surrounding environment (for example, a work room or a workbench) to acquire still image data using the wearable terminal apparatus 20 (not illustrated).

The image data, etc., thus acquired contributes to determination of whether or not the tool to be used (brush) is correct for use in the relevant task and determination of whether or not the performed task action is correct by referring to the image data, etc., accumulated in the database 13. Then, if a result of the determination is that the performed action is correct, the acquired image data, etc., are recorded as evidence information.

In this case, for determination of whether or not the tool to be used (brush) is correct for use in the relevant task, for example, a well-known individual recognition technique is employed. Here, examples of the well-known individual recognition technique include, in addition to methods in which a predetermined tag such as a barcode and an RFID (radio frequency identifier) is attached to an object for identification, e.g., an object pattern recognition technique in which an image of a fine pattern in a surface of an object (object pattern) is recognized based on image data obtained as a result of the object being shot by an image pickup apparatus, the object pattern recognition technique enabling, even in the case of industrial products uniformly manufactured, identifying each of the industrial products. When any of these individual identification techniques is employed, for example, determination is performed based on the still image data of the enlarged image of the tool to be used (brush), which has been obtained as described above, and unique tool information registered in advance in the database.

The “First part brushing” task, which is “Second task” included in the “First process: brushing” process is a task of brushing a first part of the object instrument “scissors”. Here, the first part is “Blade portions”. For work information in this case, as movie data information [D1], data of the number of times of brushing, a length of time of brushing, etc., to be detected based on a task image are included in the database. An enlarged image of the first part of the tool (brush), etc. is included as still image data information [D2].

Likewise, the “Second part brushing” task, which is “Third task” included in the “First process: brushing” process, is a task of brushing a second part of the object instrument “scissors”. Here, the second part is a “Joint portion”. Work information in this case is substantially similar to the work information for “Second task” above. In other words, as movie data information [D1], data of the number of times, a length of time, etc., of brushing is included in the database, and an enlarged image of the second part of the tool (brush), etc. is included as still image data information [D2]. FIG. 8 illustrates one scene from movie data acquired by the wearable terminal apparatus 20 when the second part (joint portion) was being brushed. Although the task illustrated in FIG. 8 is a task performed in a cleaning liquid charged in the cleaning basin 150a, in FIG. 8, illustration of the dotted shading indicating such effect is omitted.

In the “Second process: cleaning under running water” process, e.g., a water faucet is confirmed as a tool and, e.g., a flow of water (running water) from the faucet is confirmed. For work information, a prescribed length of time of the task for the object part is recorded.

In the “Third process: wiping” process, confirmation of a prescribed dedicated wiping tool such as paper or cloth for the wiping task is performed by, for example, confirming, e.g., a brand of the wiping tool based on an image of, e.g., a package of the wiping tool. For work information, a prescribed number of times, a length of time, etc., of the task for the object part are recorded.

In the “Fourth process: chemical sterilization” process, e.g., a brand of a chemical to be used for a sterilization task is confirmed based on an image of, e.g., a bottle of a prescribed dedicated bottle, for example, alcohol. For work information, a prescribed number of times, a length of time, etc., of the task for the object part are recorded.

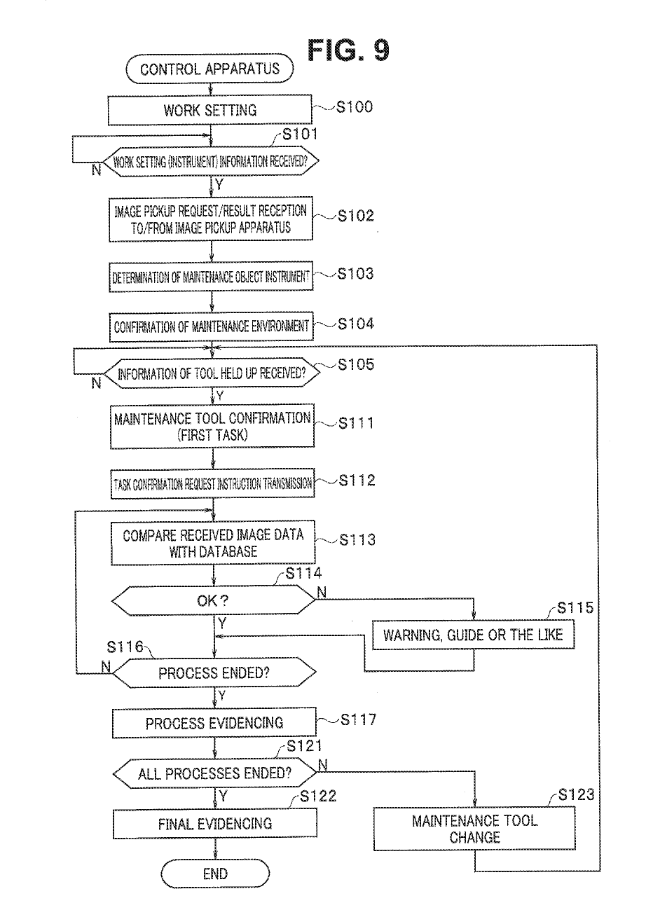

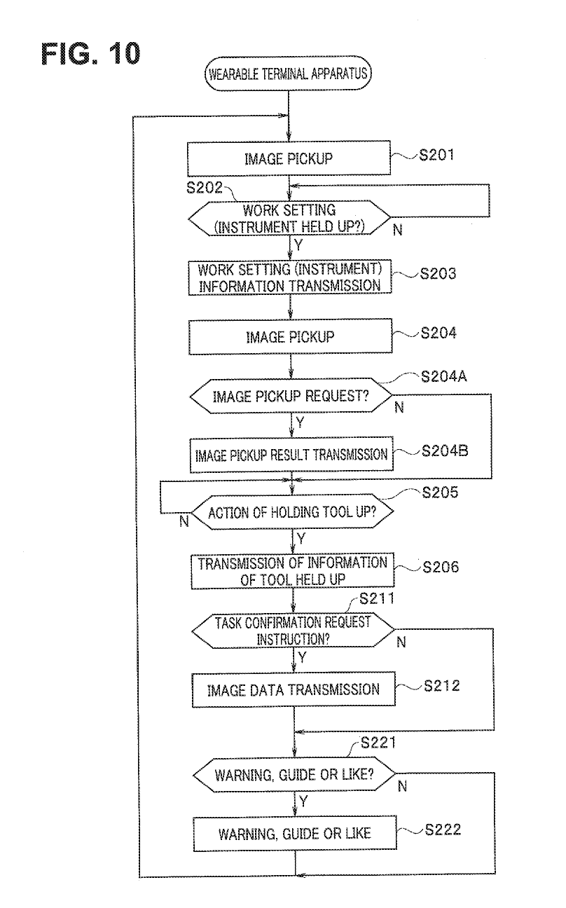

Operation when predetermined maintenance work (instrument cleaning/sterilizing work) is performed using the work support system 1 according to the present embodiment will be described below with reference to the flowcharts in FIGS. 9 and 10.

FIG. 9 is a flowchart illustrating operation of the control apparatus in the work support system according to the present embodiment. FIG. 10 is a flowchart illustrating operation of the wearable terminal apparatus (image pickup apparatus) in the work support system according to the present embodiment.

First, it is assumed that in the work support system 1 according to the present embodiment, the respective apparatuses (the control apparatus 10 and the wearable terminal apparatus 20) are in a powered-on state. In this state, an operator 100 starts predetermined work in the predetermined environment illustrated in FIG. 7. The predetermined work described here is an example of “scissors cleaning/sterilizing work” from among types of medical instrument maintenance work.

In other words, the control apparatus 10 is in a powered-on state and is waiting for receiving a predetermined instruction signal. At this time, the control apparatus 10 performs setting of desired work to be performed from that time, in advance (step S100 in FIG. 9). The wearable terminal apparatus 20 is also in a powered-on state, is in a live view image pickup operation and is waiting for an instruction signal (step S201 in FIG. 10).

The setting of the work in the control apparatus 10 does not necessarily need to be performed on the control apparatus 10 side. For example, as described later, it is possible that the work setting information is transmitted to the control apparatus 10 when an operator performs the setting on the image pickup apparatus (wearable terminal apparatus 20) side, and that the setting is performed on the control apparatus 10 side upon receipt of the work setting information.

In this state, the operator 100 starts the predetermined “scissors cleaning/sterilizing work” at a predetermined work site. First, the operator 100 takes a maintenance object instrument (scissors 200) in the “scissors cleaning/sterilizing work” in his/her hand and holds the maintenance object instrument up to the front face of the wearable terminal apparatus 20 (within the image pickup range).

Then, the control section 21 of the wearable terminal apparatus 20 determines whether or not a predetermined work setting operation has been performed. Here, a work setting operation is an operation for selecting and setting desired work to be performed from that time from among work types accumulated in advance in the database 13. This operation is performed by, for example, a predetermined operation being performed using the operation section 23 or the voice input section 27 of the wearable terminal apparatus 20. More specifically, for example, upon a work setting operation by the operator using the operation section 23 or the voice input section 27, first, display of a work list menu appears on the display section 25. The operator selects desired work in the list display using the operation section 23 or the voice input section 27. When the predetermined work is thus selected and set (step S202 in FIG. 10), the wearable terminal apparatus 20 proceeds to processing in the next step S203.

In the work setting operation performed here, besides the above-indicated example, work setting may be determined by automatically detecting a predetermined action performed by an operator, for example. More specifically, for example, an operator performs an action of holding a predetermined instrument to be subjected to work to be performed from that time, for example, scissors 200 up to the front face of the wearable terminal apparatus 20 (hereinafter abbreviated as “action of holding the instrument up”). The wearable terminal apparatus 20 determines whether or not such action has been performed (step S202 in FIG. 10). This detection processing is performed, for example, in the image determining section 21b of the control section 21 of the wearable terminal apparatus 20. Here, if the “action of holding the instrument up” is detected, the wearable terminal apparatus 20 proceeds to processing in step S203 in FIG. 10. If no “action of holding the instrument up” is detected, the detection processing is continuously repeated.

In step S203 in FIG. 10, the control section 21 of the wearable terminal apparatus 20 transmits the work setting and selection information or information to the effect that the “action of holding the instrument up” (hereinafter abbreviated “information of the instrument being held up”) to the control apparatus 10. Subsequently, the wearable terminal apparatus 20 enters a waiting state while performing the live view image pickup operation in step S204.

In step S101 in FIG. 9, the control apparatus 10 in the waiting state confirms whether or not the control apparatus 10 has received the work setting information or the “information of the instrument being held up”. Here, if reception of the “information of the instrument being held up” is confirmed, the control apparatus 10 proceeds to processing in the next step S102 in FIG. 9. If no reception of such information is confirmed, the control apparatus 10 continues waiting for reception of an instruction signal.

In step S102 in FIG. 9, the control section 11 of the control apparatus 10 transmits an instruction to make a request to perform a predetermined pickup operation (image pickup request instruction) to the wearable terminal apparatus 20. Subsequently, the control section 11 of the control apparatus 10 waits for transmission of an image pickup result (e.g., image data of the scissors 200) from the wearable terminal apparatus 20.

In step S204A in FIG. 10, the wearable terminal apparatus 20 confirms whether or not the image pickup request instruction from the control apparatus 10 has been received. Here, if reception of the image pickup request instruction is confirmed, the wearable terminal apparatus 20 performs the predetermined image pickup operation and then proceeds to processing in the next step S204B in FIG. 10.

Image data acquired by the image pickup operation performed here may include, in addition to an enlarged image data of the scissors 200, for example, image data of a surrounding environment (for example, a work room or a workbench). Acquisition of surrounding environment data enables confirmation of, e.g., whether or not the work is performed in a correct (prescribed) work environment.

Subsequently, in step S204B in FIG. 10, the wearable terminal apparatus 20 transmits information of image data (mainly, still image data), etc., acquired as a result of the image pickup operation to the control apparatus 10. Subsequently, the wearable terminal apparatus 20 waits for reception of a predetermined instruction signal while continuing performing the live view image pickup operation. Then, the wearable terminal apparatus 20 proceeds to processing in step S205.

The control apparatus 10 receives the result of the image pickup by the wearable terminal apparatus 20 (image data of the scissors 200) (step S102 in FIG. 9).

In step S204A in FIG. 10, if no reception of an image pickup request instruction is confirmed, the wearable terminal apparatus 20 waits for reception of a predetermined instruction signal while continuing performing the live view image pickup operation. Then, the wearable terminal apparatus 20 proceeds to the processing in step S205.

Referring back to FIG. 9, in the processing in step S102 above, if the control apparatus 10 receives the image pickup result from the wearable terminal apparatus 20, the control apparatus 10 proceeds to processing in the next step S103.

In step S103 in FIG. 9, the control apparatus 10 controls, e.g., the object determining section 11d and the size determining section 11e of the control section 11 to perform maintenance object instrument determination processing. The determination processing is processing to be performed with reference to the image pickup result (image data of the scissors 200) received in step S102 above and image data, etc., of the maintenance object instrument accumulated in the database 13.

Subsequently, in step S104 in FIG. 9, the control apparatus 10 also controls, e.g., the object determining section 11d and the size determining section 11e of the control section 11 to perform processing for confirming a maintenance environment. As in step S103, this confirmation processing is processing to be performed with reference to the image pickup result received in step S102 above (image data of the surrounding environment and/or the operator) and corresponding data, etc., accumulated in the database 13. Subsequently, the control apparatus 10 enters a state of waiting for reception of a predetermined instruction signal and proceeds to processing in step S105.

Subsequently, in step S105 in FIG. 9, the control apparatus 10 confirms whether or not “information of a tool being held up” has been received. Here, if reception of “information of a tool being held up” is confirmed, the control apparatus 10 proceeds to processing in the next step S111 in FIG. 9. If no reception of such information is confirmed, the control apparatus 10 continues waiting for reception of an instruction signal (looped processing in step S105).

Here, the operator 100 starts a maintenance tool confirmation task, which is the “First task” of the “First process”. As described above, a task to be performed by the operator 100 in the “First task: tool confirmation” task is an action of taking a proper tool to be used in the relevant task (cleaning brush 300) in his/her hand and holding the tool (cleaning brush 300) up to the front face of the wearable terminal apparatus 20 (within the image pickup range).

Then, in step S205 in FIG. 10, the wearable terminal apparatus 20 in the waiting state in the processing in step S204B above detects whether or not the relevant action (action of holding the cleaning brush 300 up to the front face of the wearable terminal apparatus 20; abbreviated as “action of holding the tool up”) has been performed. The detection processing is performed, for example, in the image determining section 21b of the control section 21 in the wearable terminal apparatus 20. Here, if an “action of holding the tool up” is detected, the control section 21 starts predetermined timing processing with reference to the clock section 20a and then proceeds to processing in step S206 in FIG. 10. If no “action of holding the tool up” is detected, the control section 21 continues repeating the detection processing.

In other words, the processing for detecting the relevant action (action of holding the cleaning brush 300 up to the front face of the wearable terminal apparatus 20), which is performed in the processing in step S205, is processing for detecting a point of time of a start of the first task (tool confirmation) in the first process (brushing). In other words, the processing is processing for detecting a timing of a start of the first process. Then, upon detecting a point of time of a start of the relevant action, the wearable terminal apparatus 20 starts timing at that timing. The timing processing is processing for acquiring evidence information such as information of a time that is a point of time of a start of a task and/or information of a total length of time consumed for the task. The timing processing is performed by one or both of the clock section 16 of the control apparatus 10 and the clock section 20a of the wearable terminal apparatus 20.

In the wearable terminal apparatus 20, “Image data during the task” is automatically acquired after a lapse of a predetermined length of time after the “action of holding the tool up”. At this time, the control apparatus 10 may cause the display section 25 of the wearable terminal apparatus 20 to display a guide to the effect that, for example, “an image during the task will be picked up”.

On the display section 25 of the wearable terminal apparatus 20, a reference time for the task that the operator is performing may be displayed, a length of time passed from the point of time of the start may be displayed or a prescribed length of time for the task may be displayed in a countdown form. The operator can know a reference length of time to be consumed for the relevant task (here, the second task (first part brushing) in the first process (brushing)) by viewing the time display.

Furthermore, at predetermined timing before an end of the prescribed length of time, information of a procedure to be performed before an end of the task, for example, a guide “hold the object instrument (scissors in the present example) up to the front of the image pickup apparatus” is displayed on the display section 25 of the wearable terminal apparatus 20.

When the operator views the display and follows the procedure, the wearable terminal apparatus 20 acquires enlarged image data of the object after the end of the task.

Referring back to FIG. 10, in step S206, the control section 21 in the wearable terminal apparatus 20 transmits information on the “action of holding the tool up” (abbreviated as “information of the tool being held up”) to the control apparatus 10.

In step S105 in FIG. 9, the control apparatus 10 in a standby state confirms whether or not the “information of the tool being held up” has been received. Here, if reception of the “information of the tool being held up” is confirmed, the control section 11 proceeds to processing in the next step S111 in FIG. 9. If no reception of the relevant information is confirmed, the control section 11 continues waiting for reception of an instruction signal.

In step S111 in FIG. 9, the control section 11 of the control apparatus 10 controls, e.g., the work determining section 11a to perform processing for a maintenance tool confirmation task (“first task”).

Subsequently, in step S112 in FIG. 9, the control apparatus 10 transmits a task confirmation request instruction to the wearable terminal apparatus 20 after a lapse of a predetermined length of time from a point of the start of the processing. The task confirmation request instruction is an instruction signal for requesting image data acquired by the wearable terminal apparatus 20 after the transmission of the “information of the tool being held up”.

In step S211 in FIG. 10, the wearable terminal apparatus 20 confirms whether or not the task confirmation request instruction has been received. Here, if the task confirmation request instruction has been received, the wearable terminal apparatus 20 proceeds to processing in the next step S212.

Subsequently, in the processing in step S212 in FIG. 10, the wearable terminal apparatus 20 transmits the acquired image data to the control apparatus 10. Subsequently, the wearable terminal apparatus 20 proceeds to processing in step S221. In the processing in step S212, the wearable terminal apparatus 20 may record the acquired image data in the recording section 26.

In step S113 in FIG. 9, the control apparatus 10 receives the image data received from the wearable terminal apparatus 20 in the processing in step S211 above. Then, the control apparatus 10 compares the received image data and corresponding data accumulated in the database 13 with each other. Then, based on the acquired image data, the control apparatus 10 determines whether or not the task performed by the operator 100 is correct (the prescribed task).

In the next step S114, if a result of the comparison indicates no problem, that is, it is confirmed that the task performed by the operator 100 (acquired image) is correct (the prescribed task) (OK), the control apparatus 10 proceeds to processing in the next step S116. If a result of the comparison is not OK, the control apparatus 10 proceeds to processing in step S115.

In step S115 in FIG. 9, the guide section 11c of the control section 11 in the control apparatus 10 transmits predetermined information relating to, e.g., predetermined warning display or guide display to the wearable terminal apparatus 20. Subsequently, the control apparatus 10 proceeds to the processing in step S116.

In step S221 in FIG. 10, the wearable terminal apparatus 20 confirms whether or not the information of the warning display or the guide display has been received. Here, if reception of the information is confirmed, the wearable terminal apparatus 20 proceeds to processing in the next step S222. If no reception of the information is confirmed, the wearable terminal apparatus 20 returns to the processing in step S201 above and enters a waiting state while performing the live view image pickup operation.

In step S222, the control section 21 of the wearable terminal apparatus 20 controls, e.g., the display section 25 and the voice output section 28 to provide warning display, guide display or the like in a predetermined form.

Here, the warning display, the guide display or the like includes e.g., voice information display using the voice output section 28 in addition to visual information display using the display section 25. Subsequently, the wearable terminal apparatus 20 returns to the processing in step S201 above and enters a waiting state while performing the live view image pickup operation.

In step S116, the control apparatus 10 confirms whether or not the process has ended. This confirmation is performed, for example, with reference to the database 13 or according to a predetermined instruction signal from the wearable terminal apparatus 20, for example, a signal of detection of a predetermined action or an instruction signal generated as a result of a predetermined operation using the operation section 23 or the voice input section 27. Here, if it is confirmed that the process has ended, the control apparatus 10 terminates the above-described timing processing and then proceeds to processing in the next step S117. If it is confirmed that the process has not ended, that is, if the process has not ended but has a next task, the control apparatus 10 returns to the processing in step S113 above.

In step S117, the control apparatus 10 performs evidencing processing for the ended process. The evidencing processing is processing for, e.g., recording the acquired image data, etc., in a predetermined form. For example, the evidencing processing is processing for creating a data file of image data and accompanying information including various kinds of evidence information. Subsequently, the control apparatus 10 proceeds to processing in step S121.

Subsequently, in step S121, the control apparatus 10 confirms whether or not all the processes for the work have ended. Here, if an end of all the processes is confirmed, the control apparatus 10 proceeds to processing in the next step S122. Also, if no end of all the processes is confirmed, the control apparatus 10 proceeds to processing in step S123.

Here, if all the processes for the work have not ended, the operator 100 swaps (changes) the maintenance tool in his/her hand (tool used in the previous task) for (to) a maintenance tool to be used in a next task (for example, a second task).

In this case, in step S123 in FIG. 9, the control apparatus 10 confirms a maintenance tool change. Subsequently, the control apparatus 10 returns to the processing in step S105 and repeats the subsequent processing in a similar manner.

If an end of all the processes is confirmed in the processing in step S121 above and the control apparatus 10 proceeds to the processing in step S122, in step S122, the control apparatus 10 performs final evidencing processing. The final evidencing processing is, e.g., processing for creating files of the plurality of image data, etc., acquired as predetermined position files and creating, e.g., a checklist based on an OK signal outputted in the processing in step S114 above. Subsequently, the control apparatus 10 ends all the processing and returns to a waiting state.

As described above, according to the above-described embodiment, the work support system 1 causes the image pickup apparatus (wearable terminal apparatus 20) and the control apparatus 10 to operate in cooperation with each other, enabling providing work support for reliably performing predetermined sequential work including a plurality of tasks according to a prescribed work procedure and work method and thus enabling preventing mistakes in the work.

A predetermined action during work, a used tool and conditions such as a surrounding environment can also be recorded in the form of images and thus evidenced. Therefore, it is possible to ensure after the work that predetermined work was reliably performed as prescribed.

In this case, various kinds of evidence information are associated with image data acquired by the image pickup apparatus (wearable terminal apparatus 20) and recorded as, for example, accompanying information for the image data. Consequently, for example, even after a lapse of a considerable length of time from an end of the work, evidence information of the time of the work can easily be confirmed merely by checking a plurality of image data acquired during the work.

Image data acquired during work is effectively utilized, mistakes in work are prevented based on a plurality of image data acquired and work information accumulated in advance in the database, and if a work mistake occurs, a warning is given to an operator and a correct procedure is guided, enabling support for performing reliable work.

Work mistakes (for example, an omission in a procedure or a mistake in order in the procedure and negligence of a prescribed task) can reliably be prevented, and thus, anyone can smoothly and reliably perform prescribed work and evidence of progress of work can also easily be recorded.

For using the work support system, work for recording evidence information relating to sequential work is automated and support for presenting, e.g., a timing for acquiring evidence information as work guide information to an operator during the work is provided And when image data is recorded as evidence information, accompanying meta data including various kinds of evidence information is recorded in the relevant image data file, enabling more efficient work. Concurrently, the acquired evidence information can more efficiently be managed.

Furthermore, according to the present embodiment, an evidence information system that reliably monitors work, records a result of the work and creates images of a series of motions in predetermined work as evidence can be configured.

Therefore, for example, even when a problem occurs in, e.g., a relevant work object after the work, a person can easily trace a flow of the relevant sequential work while viewing already-acquired images, and abundant information in the images ensures mechanical traceability, enabling ensuring more steady and solid reliability for, e.g., work object products.

The example work (instrument cleaning/sterilizing work) described in the above embodiment has been described in terms of a case where all the work processes from the first to fourth processes are performed at the same site. However, a work method according to the present invention is not limited only to the method of such a case, but it is possible that some of the work processes are performed at a different site instead of the same site, depending on the work, for example.

For example, in the example work (instrument cleaning/sterilizing work) described in the above embodiment, it is possible that the first process and the second process are performed at the workbench 150 including the cleaning basin 150a, and that the third process and the fourth process are performed at another workbench (not illustrated) located at a site that is different from the site of the workbench 150.

This is because the first process and the second process are cleaning work performed in the vicinity of a water facility, but the third process and the fourth process are work desirably performed at a dry site. In such a case, on another workbench (not illustrated), the work of the third process and the fourth process is performed and an auxiliary camera that is equivalent to but separate from the auxiliary camera 30 may be disposed. Such a separate auxiliary camera may be configured to also operate in cooperation with the control apparatus 10 and also operate under the control of the control apparatus 10.

Although the above embodiment describes an example using the wearable terminal apparatus 20 only as an image pickup apparatus, the present invention is not limited to the form of this example, but for example, a configuration in which a plurality of image pickup apparatuses are used and the plurality of image pickup apparatus are systematically controlled by a single control apparatus 10 is possible.

In this case, for example, a mode in which an image pickup apparatus (which may be a normal camera having a general form) having a form that is different from the form of the wearable terminal apparatus 20 is provided and the image pickup apparatus is, for example, mounted on the workbench 150 as an auxiliary camera and installed so as to be directed to an operator is conceivable.

In the case of such a mode, the auxiliary camera can acquire work information that is different from work information acquired by the wearable terminal apparatus 20 (work information corresponding to the operator's visual line).

In other words, the auxiliary camera can acquire information from a point of view that is different from a point of view of an image corresponding to the operator's visual line, or an objective standpoint, and the system thus can obtain more information.

More specifically, for example, the auxiliary camera is arranged at a position at which a work object and the vicinity of the hands of an operator treating the object are at least included in an image pickup area or is arranged in such a manner that an image of the entire operator is included in the image pickup area so that the operator during the work can be confirmed as well.

Consequently, for example, whether or not the operator wears correct (prescribed) equipment, more specifically, for example, a mask, gloves, face protection equipment, etc., can be confirmed and evidence information of such confirmation can be acquired.

As a mode using an auxiliary camera, in addition to the above-described example in which an auxiliary camera is mounted on the workbench 150, various modes of arrangement of an auxiliary camera are conceivable.

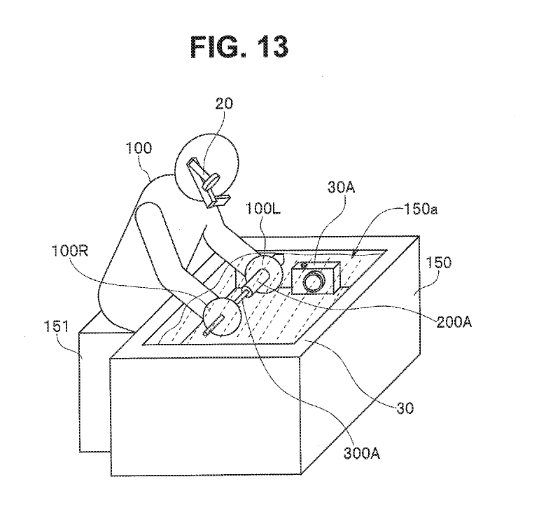

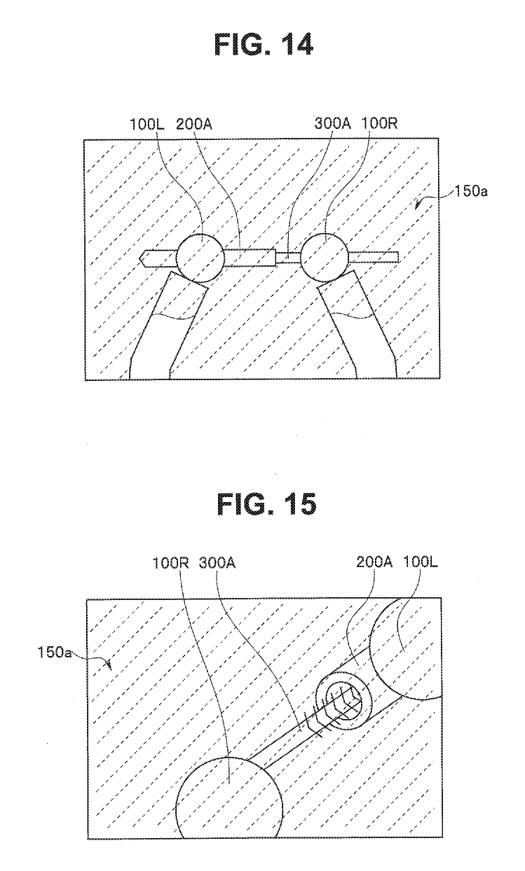

For example, it is conceivable that an auxiliary camera is disposed in the liquid in the cleaning basin 150a. FIG. 13 illustrates a case of such a configuration. FIG. 13 is a conceptual diagram illustrating how predetermined maintenance work (instrument cleaning/sterilizing work) is performed using a work support system according to a modification of the embodiment. FIG. 14 is a diagram illustrating one scene from movie data acquired by a wearable terminal apparatus in the modification in FIG. 13. FIG. 15 is a diagram illustrating still image data acquired by an auxiliary camera in the modification in FIG. 13.

In the case of this modification, an auxiliary camera 30A disposed in a liquid is an image pickup apparatus having a waterproof function. If the auxiliary camera 30A is provided in the liquid in a cleaning basin 150a as described above, work in the liquid can more clearly be recorded.

In the case of such a configuration as above, it is necessary to use a wired cable for communication between the auxiliary camera 30A and a control apparatus 10 or expose a wireless communication antenna on a water surface.

For the form of the wearable terminal apparatus 20, in addition to the forms of the wearable terminal apparatuses 20 in the embodiment and the modification described above, for example, a configuration in which an image pickup function is incorporated integrally in face protection equipment or the like to be worn by an operator without fail when the operator performs work can be employed. A wearable terminal apparatus having such a configuration enables removing an operator's burden of wearing a separate wearable terminal apparatus because the operator has to wear the face protection equipment without fail before work and also prevents the operator from making a mistake of forgetting to wear a wearable terminal apparatus.

Incorporation of functions, which are on the level equivalent to the functions of the control section of the above-described control apparatus 10, into the apparatus (wearable terminal apparatus 20) enables provision of a wearable apparatus including not only an image pickup section configured to acquire visual line image data in order to acquire a piece of work information corresponding to an operator's visual line, but also a database in which pieces of work information including pieces of image information from a plurality of fields of vision, the pieces of image information relating to predetermined work, are accumulated in advance, a communication section configured to acquire an auxiliary image from an auxiliary camera apparatus provided at a position that is different from a position of the operator, and a work determining section configured to search for or determine a piece of work information in the database based on first image data and second image data, and a system in which the database is provided outside the apparatus and the apparatus searches the database may be employed. The same applies to the auxiliary camera.

As described above, according to the present embodiment, an evidence information system that reliably monitors work, records a result of the work and creates an image of evidence can be configured, which causes increased reliability because a person can easily trace the work viewing images (e.g., when a problem occurs in a work object) and abundant information in images ensures mechanical traceability.

Each of the processing sequences described in the above embodiment can be changed in proceeding as long as such a change is contrary to the nature of the processing sequence. Therefore, in each of the above processing sequences, for example, the order of respective processing steps to be performed may be changed, a plurality of processing steps may be performed simultaneously or the order of respective processing steps may be different each time a processing sequence is executed. In other words, even though the operation flows in the claims, the description and the drawings are described using terms such as “first” and “next” for the sake of convenience, the use of such terms does not mean that it is essential to perform the operation flows in the stated order. It should also be understood that the respective steps included in these operation flows may arbitrarily be omitted as long as such omission does not affect the spirit of the invention.

From among the techniques described here, many of the control and functions described mainly with reference to the flowcharts can often be set by software programs, and the above control and functions can be provided by the software programs being read and executed by a computer.

Here, for simplicity of description, the description has been given solely on a case where a control section configured to perform overall control, but each of individual devices may have a control function of such a control section. A wearable apparatus may have such a control function or a wearable apparatus can be considered as a part of a control apparatus. What has been referred to as an auxiliary camera may have the function of the control apparatus and control a wearable apparatus, or a system in which a control apparatus includes an auxiliary camera may be employed. Furthermore, it is possible that these devices report progress of respective steps via communication and that some of the devices jointly function as a control apparatus.

Each of the aforementioned software programs is electronic data, an entirety or a part of the electronic data being stored or recorded in, e.g., a storage medium or a storage section, more specifically, a storage medium, for example, a portable medium such as a flexible disk, a CD-ROM or a non-volatile memory, or a hard disk or a volatile memory, in advance in a product manufacturing process, as a computer program product. These recording mediums may be arranged in a dispersed manner in order to share control among the devices. Aside from the above, the software programs can be distributed or provided before product shipment or via a portable medium or a communication channel. Even after product shipment, a user can make these software programs operate by downloading the software programs via, e.g., a communication network or the Internet and or installing the software programs in a computer from a storage medium, enabling easy provision of an image pickup apparatus according to the present embodiment.

It should be understood that the present invention is not limited to the above-described embodiment but various modifications and applications are possible without departing from the spirit of the invention. Furthermore, the above embodiment includes various phases of the invention, and various aspects of the invention can be extracted by appropriate combination of a plurality of components disclosed. For example, even if several components are deleted from all the components in the above-described embodiment, the configuration with the components deleted can be extracted as an aspect of the invention as long as such configuration can solve the problem to be solved by the invention and provide effects of the invention. Furthermore, components in different embodiments may appropriately be combined. This invention is not limited by any particular embodiment of the invention except that the invention is limited by the accompanying claims.

What is claimed is:

1. A work support system comprising:
an image pickup apparatus configured to acquire image data;
a control apparatus configured to acquire pieces of process information chronologically managed in a database; and
a recording apparatus configured to record the image data acquired by the image pickup apparatus, in association with meta data including a piece of process information corresponding to the image data, from among the pieces of process information acquired by the control apparatus, and shooting time information.

2. The work support system according to claim 1, wherein for each piece of process information, a plurality of work elements that can be each determined based on an image, each of the plurality of work elements being confirmable by image data obtained by the image pickup apparatus, are recorded in the database.

3. The work support system according to claim 1, wherein the image pickup apparatus is a wearable terminal apparatus configured to acquire image data in an image pickup range that is substantially equivalent to an operator's range of vision.

4. The work support system according to claim 1, wherein the meta data includes the piece of process information corresponding to the image data and work time information relating to the piece of process information.

5. The work support system according to claim 1, wherein the image pickup apparatus acquires image data on a predetermined task-by-task basis.

6. An image pickup apparatus comprising:
an image pickup unit configured to acquire image data;
a communication apparatus configured to communicate with a database in which work information including image information relating to predetermined work is accumulated in advance;
a control apparatus configured to acquire pieces of information on work performed; and
a recording apparatus configured to record the image data acquired by the image pickup unit, in association with meta data including a piece of work information corresponding to the image data from among the pieces of work information acquired by the control apparatus.

7. A wearable apparatus comprising:
an image pickup unit configured to acquire image data corresponding to an operator's visual line;
a communication apparatus configured to communicate with a database in which work information including image information relating to predetermined work is accumulated in advance;
a control apparatus configured to acquire pieces of work information on work performed; and
a recording apparatus configured to record the image data acquired by the image pickup unit, in association with meta data including a piece of work information corresponding to the image data from among the pieces of work information acquired by the control apparatus.

8. A work support method comprising:
a process information acquisition step of acquiring particular pieces of process information from a plurality of pieces of process information chronologically managed in a database;
an image acquisition step of acquiring image data from an image pickup apparatus; and
a recording step of recording the image data acquired by the image pickup apparatus, in association with meta data including a piece of process information corresponding to the image data, from among the pieces of process information acquired, and shooting time information.
